(19) United States
(12) Patent Application Publication
(10) Pub. No.: US 2003/0063469 A1
(43) Pub. Date: Apr. 3, 2003

(54) Structure storable lamp shade

(76) Inventor: Shih-Ming Lin, Chang Hua Hsien (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/968,861

(22) Filed: Oct. 3, 2001

(51) Int. Cl. F21V 1/06

(52) U.S. Cl. 362/352; 362/356; 362/358

(57) ABSTRACT

An improved structure storable lamp shade comprised of a top ring, a bottom ring, frame members pivotably conjoined between the top ring and the bottom ring, and a fabric surfacing. A beveled bottoming segment at the point of confluence between the upper support rods and the lower support rods provides for the appropriate posturing of the upper and lower support rods and prevents the slipping of the dual-rod frame members, while also facilitating the disengagement of the upper support rods and the lower support rods. A catch section projects from the bottom outer end of the upper support rod and a lock section is disposed at the bottom surface of the lower support rod and, furthermore, the catch sections are held in place by the lock sections, thereby preventing the unintentional disengagement of the dual-rod frame members. When the lamp shade is folded, the fabric surfacing is doubled over at the same time, with the structure thereby providing for simple assembly and, furthermore, reduced storage and transport dimensions as well as lowered shipping costs.

### BACKGROUND OF THE INVENTION

1) Field of the Invention

The invention herein relates to an improved structure storable lamp shade, the structural features of which include a beveled bottoming segment situated at the top ends of the upper support rod and the lower support rod of the frame members, with a catch section and a lock section formed at the bottom ends of the upper support rods and the lower support rods that prevents the slipping of the dual-rod frame members; furthermore, when the lamp shade is folded, the fabric surfacing is doubled over at the same time, with the said structure thereby providing for simple assembly and, furthermore, reduced storage and transport dimensions as well as lowering shipping costs.

2) Description of the Prior Art

A conventional lamp shade 5, referring to FIG. 5, typically has its frame members permanently fixed between the top ring and the bottom ring to form a lamp shade structure; however, since the conventional lamp shape 5 is in a structural arrangement that is of an unyielding shape, when it is packaged in a carton, the lamp shade 5 cannot be forcefully diminished in side such that products occupy considerable space and a reduction in storage and transport dimensions is not possible, which leads to a proportional increase in product shipping costs and results in greater overhead.

### SUMMARY OF THE INVENTION

The primary objective of the invention herein is to provide an improved structure storable lamp shade comprised of a top ring, a bottom ring, frame members pivotably conjoined between the top ring and the bottom ring, and a fabric surfacing; a beveled bottoming segment at the point of confluence between the upper support rods and the lower support rods provides for the appropriate posturing of the upper and lower support rods prevents the slipping of the dual-rod frame members, while also facilitating the disengagement of the upper support rods and the lower support rods; a catch section projects from the bottom outer surface of the said upper support rod and a lock section is disposed at the bottom surface of the lower support rod and, furthermore, the catch sections are held in place by the lock sections, thereby preventing the unintentional disengagement of the dual-rod frame members.

Another objective of the invention herein is to provide an improved structure storable lamp shade, the structural features of which include a beveled bottoming segment situated at the top extremities of the upper support rod and the lower support rod of the frame members, with a catch section and a lock section formed at the bottom extremities of the upper support rods and the lower support rods; when the lamp shade of the present invention is folded, since the bottoming segment is of a beveled design, the upper support rods and the lower support rods can be pulled apart to release of the upper support rod catch sections from the lower support rod lock sections such that the top and bottom rings collapse toward the center and the upper and lower support rods pivot into closure at the pin; furthermore, when the lamp shade is folded, the fabric surfacing is doubled over at the same time, with the said structure thereby providing for simple assembly and, furthermore, reduced storage and transport dimensions as well as lowering shipping costs.

### BRIEF DESCRIPTION OF THE DRAWINGS

FIG. 1 is an exploded drawing of the invention herein.

FIG. 2 is an isometric drawing of the invention herein.

FIG. 3 is an isometric drawing of the invention herein in the folded state.

FIG. 4 is an orthographic drawing of the invention herein in the semi-folded state.

FIG. 5 is an isometric drawing of a conventional lamp shade.

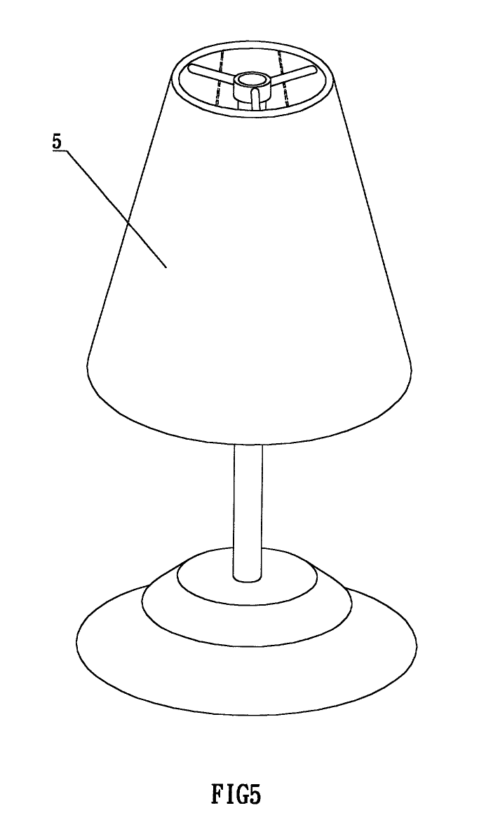

### DETAILED DESCRIPTION OF THE INVENTION

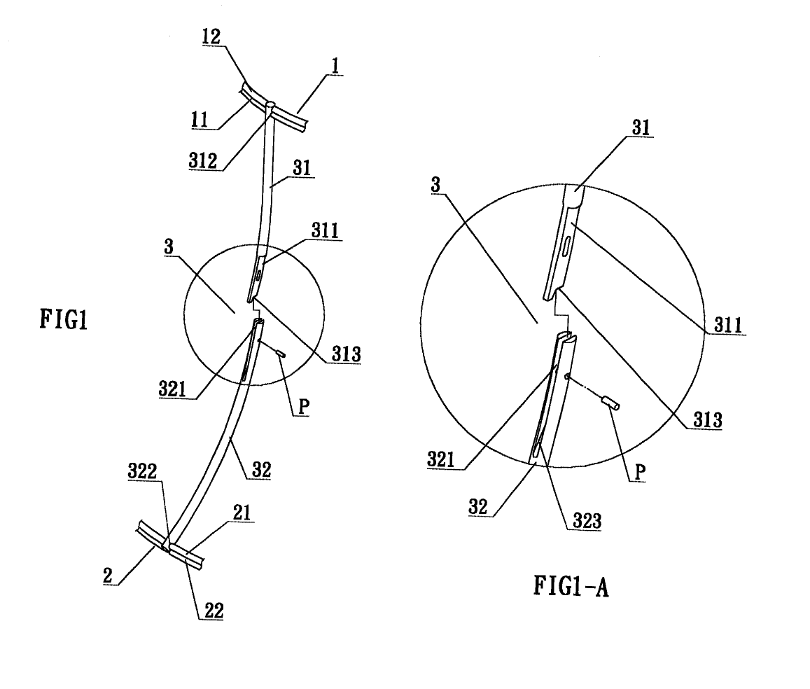

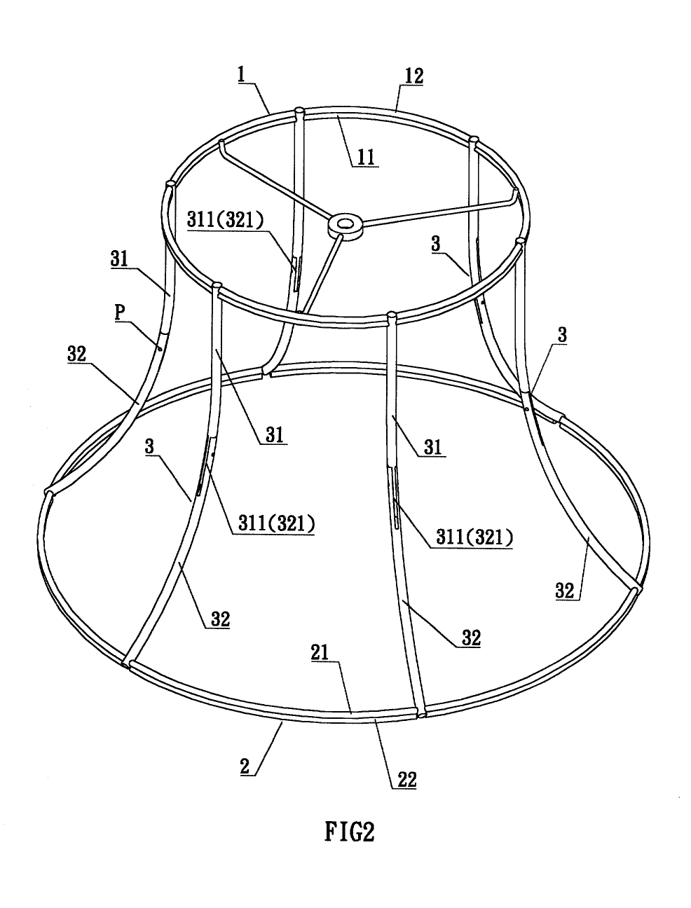

Referring to FIG. 1 and FIG. 2, the structural arrangement of the invention herein, the present invention is comprised of a top ring 1, a bottom ring 2, frame members 3 pivotably conjoined between the top ring 1 and the bottom ring 2, and a fabric surfacing 4, in which:

The said top ring 1 consists of an upper hoop 11 that is inserted and welded into the open ends at the top extremity of the frame members 3 and a fixing circlet 12 that is respectively attached at a plurality of sections over the upper hoop 11 ensconced at two sides of the frame members 3 to maintain the upper hoop 11 on the frame members 3 by preventing the movement of the upper hoop 11.

The said bottom ring 2 is of a diameter that is larger than that of the top ring 1, the bottom ring 2 consisting of a lower hoop 21 that is inserted and welded into the open ends at the bottom extremity of the frame members 3 and a fixing circlet 22 that is respectively attached at a plurality of sections over the lower hoop 21 ensconced at two sides of the frame members 3 to maintain the lower hoop 21 on the frame members 3 by preventing the movement of the lower hoop 21.

Each said frame member 3 consists of an upper support rod 31 having a plane surface 311 cut into the two sides of its bottom end and a lower support rod 32 having a slot 321 formed in its top end and, furthermore, a hole 312 and 322 is formed in bottom ends of the upper support rod 31 and the lower support rod 32, respectively, to provide for the insertion and positioning of the top ring 31 and the bottom ring 32; the slots 321 of the lower support rods 32 fit over the plane surfaces 311 of the upper support rods 31 and a hinge pin P is inserted at an appropriate position in the center sections of the frame members 3.

At the area of confluence between the plane surfaces 311 of the upper support rods 31 and the slots 321 of the lower support rods 32 is a bottoming segment 33 that is contoured outward and upward; of a beveled design, the bottoming segment 33 prevents the slipping of the upper and lower support rods 31 and 32, while also facilitating the disengagement of the upper support rods 31 and the lower support rods 32.

In addition, a catch section 313 projects from the bottom lateral end of the said upper support rod 31 plane surfaces 311 and a matching lock section 323 is disposed at the bottom inner side of the lower support rod 32 slots 321 and, furthermore, after the upper support rods 31 are inserted into the lower support rods 32, the catch sections 313 snap into the lock sections 323 and are held in place by the lock sections 323, thereby preventing the unintentional disengagement of the frame members 3.

The said fabric surfacing 4 of the lamp shade is tightly wrapped around outer periphery of the top ring 1 and the bottom ring 2 and, furthermore, after the fabric surfacing 4 is stretched open, it is capable of exerting a certain degree of pressure against the two ends of the frame members 3 that reinforces the positioning of the frame members 3 and prevents the disengagement of the upper and lower support rods 31 and 32.

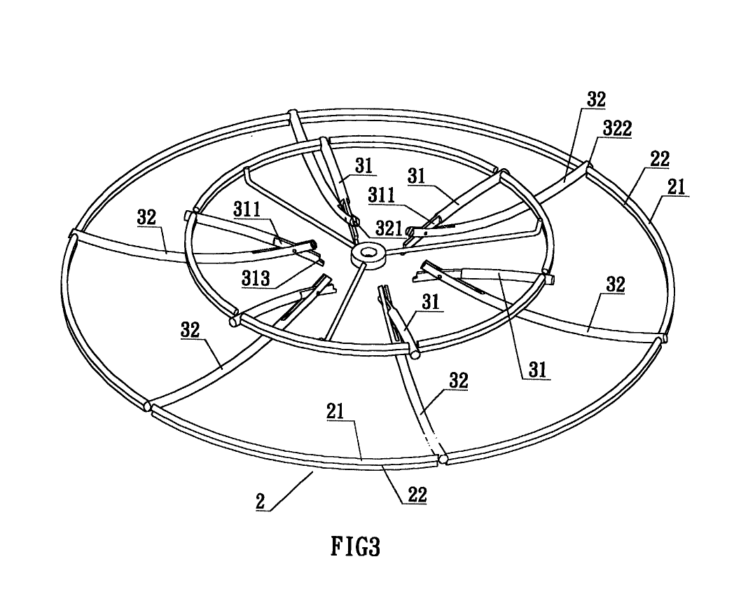

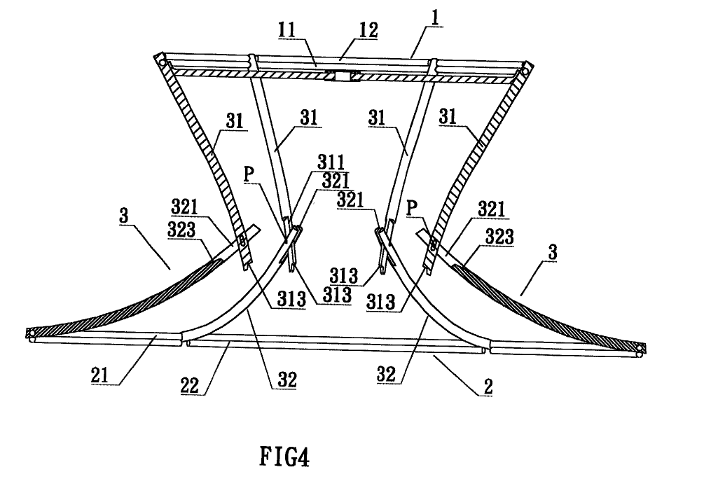

Referring to FIG. 3 and FIG. 4, the drawings depicting the operation of the invention herein, due to the structural features of the beveled bottoming segment 33 at the top extremities of the frame member 3 upper support rods 31 and lower support rods 32 as well as the catch sections 313 and lock sections 323 at the bottom extremities of the upper support rods 31 and lower support rods 32, when the lamp shade of the present invention is folded, since the bottoming segment 33 is of a beveled design, the upper support rods 31 and the lower support rods 32 can be pulled apart to release the upper support rod 31 catch sections 313 from the lower support rod 32 lock sections 323 such that the top and bottom rings 1 and 2 collapse toward the center and the upper and lower support rods 31 and 32 pivot into closure at the pin P; furthermore, when the lamp shade is folded, the fabric surfacing 4 is doubled over at the same time, with the said structure thereby providing for simple assembly and, furthermore, reduced storage and transport dimensions as well as lowered shipping costs.

1. An improved structure storable lamp shade comprised of a top ring, a bottom ring, frame members pivotably conjoined between the said top ring and the said bottom ring, and a fabric surfacing; the said top ring and the said bottom ring each consist of a hoop that is inserted into the upper and lower extremities of the said frame members and a fixing circlet that is respectively attached at a plurality of sections over the said hoops ensconced at two sides of the said frame members to maintain the said hoops on the said frame members, the innovative features of which includes:
The said frame members each have a hole in their upper and lower ends to provide for the insertion and positioning of the said top ring and the said bottom ring; each said frame member consists of an upper support rod having plane surfaces cut along the two sides of its bottom end and a lower support rod having a slot formed in its top end:
Each said frame member consists of the said upper support rod having the said plane surface cut along the two sides of its bottom end and the said lower support rod having the said slot formed in its top end and, furthermore, the said holes are formed in the bottom ends of the upper support rod and the lower support rod, respectively, to provide for the insertion and positioning of the said top ring and the said bottom ring; the said slots of the said lower support rods fit over the said plane surfaces of the said upper support rods and a hinge pin is inserted at an appropriate position in the center sections of the said frame members.
The said fabric surfacing of the lamp shade herein is tightly wrapped around outer periphery of the said top ring and the said bottom ring and, furthermore, after the said fabric surfacing is stretched open, it is capable of exerting a certain degree of pressure against the two ends of the said frame members that reinforces the positioning of the said frame members.
As such, when the lamp shade is folded, the said fabric surfacing is doubled over at the same time, with the said structure thereby providing for simple assembly and, furthermore, reduced storage and transport dimensions as well as lowered shipping costs.

2. As mentioned in claim 1 of the improved structure storable lamp shade of the invention herein, at the point of confluence between the said upper support rods and the said lower support rods is a bottoming segment that is contoured outward and upward; of a beveled design, the said bottoming segment prevents the slipping of the said upper and lower support rods, while also facilitating the disengagement of the said upper support rods and the said lower support rods.

3. As mentioned in claim 1 of the improved structure storable lamp shade of the invention herein, a catch section projects from the bottom outer end of the said upper support rod plane surfaces and a matching lock section is disposed at the bottom inner side of the said lower support rod slots and, furthermore, after the said upper support rods are inserted into the said lower support rods, the said catch sections snap into the said lock sections and are held in place by the said lock sections, thereby preventing the unintentional disengagement of the said frame members.
